(19) United States
(12) Patent Application Publication
(10) Pub. No.: US 2026/0357124 A1
(43) Pub. Date: Nov. 12, 2026

(54) PROCESS FOR TREATING SUBTERRANEAN FORMATIONS

(71) Applicant: POWELTEC, Rueil Malmaison (FR)

(72) Inventors: Alain ZAITOUN, Rueil Malmaison (FR); Nicolas GAILLARD, Rueil Malmaison (FR); Nazanin SALEHI, Rueil Malmaison (FR); Jérôme BOUILLOT, Rueil Malmaison (FR)

(21) Appl. No.: 19/121,548

(22) PCT Filed: Oct. 17, 2023
(86) PCT No.: PCT/EP2023/078784

§ 371 Date: Apr. 16, 2025

(30) Foreign Application Priority Data
Oct. 18, 2022 (EP) 22306575.6

(51) Int. Cl. C09K 8/588

(52) U.S. Cl. CPC C09K 8/588

(57) ABSTRACT

The invention relates to a method for diverting flow of water in a subterranean formation said method comprising injecting a first composition comprising microgels and water, a second composition that can generate a gel in the subterranean formation and comprising at least a polymer, a crosslinker and water, and a third composition comprising water and optionally one or more viscosifying agent.

The present invention relates generally to hydrocarbon recovery. More particularly, the invention relates to a method for improving the conformance and/or fluid profiles in a subterranean formation from which hydrocarbons are to be recovered.

### STATE OF THE ART

Hydrocarbons, in particular oil, are recovered from subterranean formations, also called reservoirs, by different techniques. At the beginning of the production, a well is drilled and because of the pressure of the reservoir, oil is produced by simple depressurization. With time, the pressure of the reservoir decreases and operators need to inject a displacement fluid (either gas or water) to pressurize the reservoir and promote the production of the remaining oil. Usually, operators inject the fluids in so called “injection wells” and produce oil in “production wells”. When injected, the displacement fluid, in particular water, propagates in the reservoir pushing the mobile hydrocarbons towards the production well.

The effectiveness of oil displacement floods can be reduced by conformance problems in the reservoir. Indeed, reservoirs are subterranean formation containing different rock layers that are characterized by their permeabilities. From one layer to another, the permeability can be different. Permeability can vary even within the same layer. When the displacement fluid, in particular water, is injected in an injection well, it will preferentially penetrate in the layer having the less resistance to flow which is in general the layer having the highest permeability. As a consequence, the zones of the reservoir having lower permeabilities remain un-swept leaving oil from these layers in the reservoir. The presence of fractures or fracture networks or other structural anomalies in the rock matrix can also pose the same problem.

Several prior art methods have been proposed to divert the flow of a displacement and/or treatment fluid, in particular water, from higher permeability layers towards lower permeability layers within a subterranean formation. Some of these methods consist in insolating the high permeability zone using a valve or a packer or a sleeve at the well bore face in connection with the reservoir. This method is only efficient if there is no connectivity between the different zones of the reservoir and the accessibility to the zone to be isolated may be impossible because of the completion of the well.

Another way in which the forgoing conformance problems can be addressed is through conformance control treatments whereby high permeability zones are fully or partially plugged to fluid flow by injecting a gelling agent. By plugging formation flow paths having high permeability, the subsequent injected displacement fluid preferentially sweeps formation flow paths having low permeability and displaces more oil, promoting thus increased oil recovery.

U.S. Pat. Nos. 4,773,481 and 4,683,949 describe the injection of crosslinked acrylamide-based polymer gels to decrease the permeability or plug the layer having the highest permeability or fractures. However, the injection of such treatments is not selective because it can penetrate all the layers with different depth of penetration. Obviously, for layers with lower permeabilities, the depth of penetration is shorter than for the ones with higher permeabilities. The gelation of treatment at the entrance of those layers will occur eventually and will block the subsequent injection of water. The bull head injection of such treatment is risky because it is not selective. Operators can inject selectively those gel treatments through a coiled tubing that will target the zone of injection in the open interval. However, this requires a work over unit and a lot of operations that have a significant cost and will require long time and difficult deployment for the whole treatment.

U.S. Pat. No. 8,016,034 describes the injection of a pre-flush using a degradable product that will protect some layers from the further injection of another fluid. Once the principal treatment has been injected in the target zone, the access to the protected layer is restored where a second fluid can be injected. For this process, the liberation of the “protected” layer can be controlled by the injection of a fluid containing specific chemicals which add operations and chemicals to the whole treatment. Furthermore, this technology requires a specific product that is degradable under the action of chemicals, temperature or radiation, or which can be degraded with time in the reservoir. The operators cannot control this parameter and in case of problem, for example the pull-out of the injection pump, the treatment has to be performed once again because the product would have been degraded. The use of radiation to degrade the treatment requires more operations and needs to target the specific zone where the degradable product has been placed which is challenging. As a consequence, this method requires a lot of control of operations to ensure that the degradable product is either well placed before the injection of the treatment fluid and to ensure that it has been removed before the injection of the subsequent fluid.

Therefore, there is a need for improving the techniques of conformance control in subterranean formations to be more selective and to allow the high permeability zones to be treated first while keeping the low permeability zones accessible for subsequent displacement fluid to recover oil.

There is also a need for developing cost-and time-effective techniques to improve the fluid displacement efficiency during oil recovery processes.

EP2288631 and U.S. Pat. No. 8,263,533 disclose methods for the treatment of rock formations comprising the injection into the formation of a microgel.

US2006/278390 discloses a method of diverting a treatment fluid in a formation comprising the injection into the formation of a crosslinkable polymer and a treatment fluid.

US2014/144628 discloses a method for increasing the recovery of hydrocarbon fluids in a formation comprising the injection into the formation of an expandable acrylamide-based polymeric microparticles.

The applicant has unexpectedly found that improved injectivity profiles and/or improved conformance can be obtained by the bull heading injection of a slug of an aqueous solution of microgels which will protect the relatively low permeability layers from the invasion of the subsequent injection of gel so that those low permeability layers are still available for water invasion once the gel formulation is placed in the reservoir.

As hereinafter detailed, the applicant has developed a novel method for improving conformance and/or sweep efficiency, in particular for reducing permeability in at least one relatively highly permeable zone of a subterranean formation also containing at least one relatively less permeable zone, said formation being penetrated by at least a well in fluid communication therewith, the method comprising first the injection of an aqueous composition comprising a specific microgel, and secondly the injection of an aqueous composition capable of generating a gel in situ in the subterranean formation.

### SUMMARY OF THE INVENTION

The invention relates to a method for improving conformance in hydrocarbon-bearing heterogeneous subterranean formations and/or for improving flow profiles and sweep efficiencies of fluids injected in said formations and/or for diverting fluids injected in said formations, the method comprising the steps of:
(i) injecting a first aqueous composition comprising microgels obtained by dispersing in water (a) a self-invertible inverse latex or of a self-invertible inverse microlatex of a crosslinked polyelectrolyte, or (b) a powder obtained by drying and/or atomization of said self-invertible inverse latex or said self-invertible inverse microlatex, the crosslinked polyelectrolyte being obtained by copolymerization in the presence of a crosslinking agent of:
at least one anionic monomer,
with at least one neutral monomer,
(ii) injecting a second aqueous composition capable of generating a gel in the subterranean formation,
(iii) injecting a third aqueous composition comprising at least water and optionally one or more viscosifying agents.

Advantageously, the anionic monomer is selected from the group consisting of (meth)acrylic acid, itaconic acid, crotonic acid, maleic acid, fumaric acid, 2-methyl-2-[(1-oxo-2-propenyl)amino]-1-propanesulfonic acid, vinylsulphonic acid, vinylphosphonic acid, allylsulphonic acid, allylphosphonic acid, styrene sulphonic acid and their salts of an alkali metal, an alkaline earth metal and ammonium, and mixtures of these monomers.

Preferably, the proportion of the anionic monomer units in the crosslinked polyelectrolyte is from 1 to 75 mol %, preferably from 5 to 40 mol %.

Advantageously, the neutral monomer is selected from the group consisting of: acrylamide; N, N-dimethylacrylamide; N-[2-hydroxy-1,1-bis(hydroxymethyl)-ethyl]propenamide; 2-hydroxyethyl acrylate; N-vinylpyrrolidone; and mixtures thereof.

Preferably, the proportion of neutral monomer units in the crosslinked polyelectrolyte is from 10 to 90 mol % and preferably from 50 to 70 mol %.

Advantageously, the crosslinked polyelectrolyte is obtained by copolymerization with a further cationic monomer. Preferably, the proportion of cationic monomer units in the crosslinked polyelectrolyte is from 1 to 75 mol %, preferably from 1 to 30 mol %.

Advantageously, the microgels used in step (i) have a spherical shape and have an average size ranging from 0.05 to 10 μm, preferably from 0.1 to 8 μm, more preferably from 0.3 to 5 μm.

Advantageously, the first aqueous composition comprises an amount of microgels ranging from 500 to 10 000 ppm, preferably from 500 to 7000 ppm.

Advantageously, the second aqueous composition capable of generating a gel in the subterranean formation is a composition comprising at least one crosslinkable polymer and at least a crosslinking agent.

According to a preferred embodiment, the crosslinkable polymer is an acrylamide-based polymer.

Advantageously, the average molecular weight of the crosslinkable polymer is from 10,000 to 50,000,000 g/mol⁻¹ and preferably from 100,000 to 20,000,000 g/mol⁻¹, and most preferably from 200,000 to 15,000,000 g/mol⁻¹.

Advantageously, the second aqueous composition capable of generating a gel in in the subterranean formation comprises an amount of the crosslinkable polymer ranging from 500 to 120 000 ppm, preferably from 1000 to 110000 ppm and an amount of crosslinking agent ranging from 500 to 15 000 ppm, preferably from 500 to 12000 ppm.

Advantageously, in step (iii) of the method according to the invention, the viscosifying agent is an acrylamide-based polymer.

Advantageously, the steps i) and ii) and iii) of the method according to the invention are applied at most 21 days before any injection of a displacement fluid.

### DETAILED DESCRIPTION

The term “consists essentially of” followed by one or more characteristics, means that may be included in the process or the material of the invention, besides explicitly listed components or steps, components or steps that do not materially affect the properties and characteristics of the invention.

The expression “comprised between X and Y” includes boundaries, unless explicitly stated otherwise. This expression means that the target range includes the X and Y values, and all values from X to Y.

For the purposes of the invention, the term “treatment” relates to the injection of chemical formulations through at least an injection well in fluid communication with the formation to be treated. Injection wells are well known in the field of oil recovery and formation treatments and can be vertical, inclined or horizontal.

The present invention is intended to provide a novel method for improving conformance in hydrocarbon-bearing heterogeneous subterranean formations and for correspondingly improving flow profiles and sweep efficiencies of fluids injected in said formations, in particular displacement fluids such as water.

The method is also intended to divert displacement fluids, in particular water, in hydrocarbon-bearing heterogeneous subterranean formations.

The method is also intended to improve the oil displacement efficiency in a subterranean formation during an oil recovery process.

By “heterogeneous subterranean formation” it is intended to mean a consolidated or non-consolidated geological subterranean formation (or reservoir) having heterogeneous permeabilities, i.e., wherein the permeability varies within a single layer or between two or more layers separated or not by an impermeable layer. The variation in permeability within the formation can be vertical or horizontal and can be also due for example to the presence of fractures.

Through the present application, unless otherwise specified, by “permeability” it is intended to mean the ability of the subterranean formation/the reservoir/the rocks/the layers to transmit fluids or to be penetrated by fluids.

By “improving conformance and flow profiles” and/or “improving the oil displacement efficiency” and/or “diverting displacement fluids”, it is intended to mean improving the injectivity profile of a subterranean formation by reducing the permeability of a relatively higher permeability zone which is in fluid communication with a lower permeability zone of the formation. In other words, it is intended to mean the process of diverting fluids away from the relatively high permeability zones in the formation to a relatively less permeable zone.

By “displacement fluids” it is intended to mean aqueous fluids such as water (e.g., fresh water, salt water, brines, etc.) or gas which are supplied to the reservoir from external sources in order to mobilize and produce/extract the remaining oil in the subterranean formation. Preferably, the displacement fluid is water.

The objectives of the present invention are achieved by injecting into the subterranean formation, prior to the injection of a gelling system, an aqueous composition comprising microgels obtained by dispersing in water (a) a self-invertible inverse latex of a crosslinked polyelectrolyte or of a self-invertible inverse microlatex of a crosslinked polyelectrolyte, or (b) a powder obtained by drying and/or atomization of a self-invertible inverse latex of a crosslinked polyelectrolyte or of a self-invertible inverse microlatex of a crosslinked polyelectrolyte.

In particular, the method of the present invention comprises the steps of:
(i) injecting a first aqueous composition comprising microgels obtained by dispersing in water of a self-invertible inverse latex or of a self-invertible inverse microlatex of a crosslinked polyelectrolyte, or a powder obtained from the same, the crosslinked polyelectrolyte being obtained by copolymerization in the presence of a crosslinking agent of:
at least one anionic monomer, with
at least one neutral monomer, and
optionally at least one cationic monomer;
(ii) injecting a second aqueous composition capable of generating a gel in situ in the subterranean formation,
(iii) injecting a third aqueous composition comprising at least water and optionally one or more viscosifying agent.

The term “dispersing in water” used herein is intended to mean adding and/or diluting the self-invertible inverse latex or the self-invertible inverse microlatex in water, or adding and/or mixing the powder obtained from said latex or microlatex in water.

The method according to the invention can be carried out by injecting the different compositions into the subterranean formation through at least a well in fluid communication therewith.

It is noted that, for the purpose of the invention, the third aqueous composition to be injected in step iii) of the method according to the invention is distinct from the injection of a displacement fluid to pressurize the reservoir and promote the production of oil.

### The First Aqueous Composition

The method according to the invention comprises a first step (i) of injecting into the subterranean formation an aqueous composition comprising microgels obtained by dispersing in water of a self-invertible inverse latex or of a self-invertible inverse microlatex of a crosslinked polyelectrolyte, obtained by copolymerization in the presence of a crosslinking agent of:
at least one anionic monomer, with
at least one neutral monomer.

According to an alternative aspect of the present invention, the microgels are obtained by dispersing in water a powder obtained by drying and/or atomization of the self-invertible inverse latex or the self-invertible inverse microlatex described above and in details here-under. In particular, the self-invertible inverse latex or the self-invertible inverse microlatex described above can be dried and atomized beforehand before being mixed in water to form said microgels.

The term “crosslinked polyelectrolyte” denotes a nonlinear polymer in the form of a three-dimensional network and which can swell in water thus resulting in a chemical gel being obtained.

According to an aspect of the present invention, the self-invertible inverse latex or the self-invertible inverse microlatex comprises from 15 to 70% by weight, preferably from 15 to 60% by weight, more preferably from 25 to 40% by weight of said crosslinked polyelectrolyte.

The term “microgels” is intended to mean cross-linked polymer network of colloidal size that are swollen in the presence of a solvent, particularly water, and have an average size between 100 nm and several micrometers.

The anionic monomer may have acrylic, vinyl, maleic, fumaric and/or allylic functionalities and may contain a carboxyl group, a phosphonate group, and/or a sulphonate group. The anionic monomer can also be an ammonium or alkaline earth metal or alkali metal salt of the above-mentioned monomers.

Advantageously, the anionic monomer is selected from the group consisting of acrylic acid, methacrylic acid, itaconic acid, crotonic acid, maleic acid, fumaric acid, 2-methyl-2-[(1-oxo-2-propenyl)amino]-1-propanesulfonic acid, vinylsulphonic acid, vinylphosphonic acid, allylsulphonic acid, allylphosphonic acid, styrene sulphonic acid and their salts of an alkali metal, an alkaline earth metal and ammonium, and mixtures of these monomers.

According to an embodiment, the anionic monomer is selected from partially or totally salified 2-methyl-2-[(1-oxo-2-propenyl)amino]-1-propanesulfonic acid and partially or totally salified (meth)acrylic acid.

The term “partially salified” or “totally salified” means that the corresponding monomer is respectively partially salified or completely salified in the form of an alkali metal salt, such as, for example, sodium salt or potassium salt, of an alkaline earth metal or of an ammonium salt.

According to a preferred embodiment, the anionic monomer is partially or totally salified 2-methyl-2-[(1-oxo-2-propenyl)amino]-1-propanesulfonic acid (also known as 2-acrylamido-2-methylpropanesulfonic acid or AMPS™).

Advantageously, the proportion of the anionic monomer units, in the crosslinked polyelectrolyte is from 1 to 75 mol %, preferably from 5 to 40 mol %.

Advantageously, the neutral monomer is selected from the group consisting of acrylamide; N, N-dimethylacrylamide; N-[2-hydroxy-1,1-bis(hydroxymethyl)-ethyl]propenamide; 2-hydroxyethyl acrylate; N-vinylpyrrolidone; and mixtures thereof.

According to a preferred embodiment of the present invention, the neutral monomer is acrylamide.

Advantageously, the proportion of the neutral monomer units in the crosslinked polyelectrolyte is from 10 to 90 mol % and preferably from 50 to 70 mol %.

Advantageously, the molar ratio between the anionic monomer units and the neutral monomer units is from 5:95 to 95:5, preferably from 10:90 to 90:10, more preferably from 20:80 to 80:20.

According to a very preferred embodiment of the present invention, the crosslinked polyelectrolyte is a crosslinked copolymer of AMPS, partially or totally salified in the sodium salt form, and of acrylamide.

Optionally, the crosslinked polyelectrolyte is obtained by copolymerization of:
at least one anionic monomer as described above,
at least one neutral monomer as described above,
and further at least one cationic monomer.

Advantageously, the cationic monomer is selected from the group consisting of N, N, N-tetramethyl-2-[(1-oxo-2-propenyl)amino]propanammonium chloride; N, N, N-trimethyl-3-[(1-oxo-2-propenyl)amino]propanammonium chloride; diallyldimethylammonium chloride; N, N, N-trimethyl-2-[(1-oxo-2-propenyl)amino]ethanammonium chloride; N, N, N-trimethyl-2-[(1-oxo-2-methyl-2-propenyl)amino]ethanammonium chloride; N, N, N-trimethyl-3-[(1-oxo-2-methyl-2-propenyl)amino]propanammonium chloride; and mixtures thereof.

Preferably, the cationic monomer is N, N, N-trimethyl 3-[(1-oxo 2-propenyl)amino] propanammonium chloride.

When a cationic monomer is used, the proportion of cationic monomer unit in the crosslinked polyelectrolyte can vary from 1 to 75 mol %, preferably from 1 to 30 mol %.

Advantageously, the crosslinking agent is chosen from compounds comprising at least two ethylenic bonds and very particularly from diallyloxyacetic acid or one of its salts and more particularly its sodium salt, triallylamine, diallylurea, trimethylolpropane triacrylate, ethylene glycol dimethacrylate, diethylene glycol diacrylate, methylenebis(acrylamide) or a mixture of several of these compounds.

Advantageously, in the self-invertible inverse latex or the self-invertible inverse microlatex used in the first aqueous composition, the crosslinking agent is employed in the molar proportion, expressed with respect to the monomers used, of from 0.001 to 0.5% and preferably of from 0.005 to 0.25%.

Advantageously, the self-invertible inverse latex or self-invertible inverse microlatex described above comprises an emulsifying system comprising at least one surfactant of water-in-oil (W/O) type and at least one surfactant of oil-in-water (O/W) type.

The water-in-oil (W/O) type surfactant may be either a single surfactant or a mixture of surfactants provided that said mixture has a sufficiently low HLB value to induce water-in-oil emulsions.

As known in the art, the “HLB-value” is the capability of surfactants to stabilize water-in-oil-emulsions or oil-in-water emulsions and is usually a number from 0 to 20. In surfactants having a low HLB-value the lipophilic parts of the molecule predominate and consequently they are usually good water-in-oil emulsifiers. In surfactants having a high HLB-value the hydrophilic parts of the molecule predominate and consequently they are usually good oil-in-water emulsifiers.

Advantageously, the water-in-oil (W/O) type surfactant or mixtures thereof has an HLB-value of not more than 9, preferably not more than 8, and more preferably from 3 to 8.

Examples of water-in-oil surfactants include, not limitatively, sorbitan esters, in particular sorbitan monoesters with C12 to C18-groups such as sorbitan monolaurate, sorbitan monopalmitate, sorbitan monostearate, sorbitan monooleate but also sorbitan esters with more than one ester group such as sorbitan tristearate, sorbitan trioleate, ethoxylated fatty alcohols with 1 to 4 ethyleneoxy groups, e.g. polyoxyethylene (4) dodecylether ether, polyoxyethylene (2) hexadecyl ether or polyoxyethylene (2) oleyl ether, or mixtures thereof. In order to obtain the abovementioned HLB values it is possible to use, in basically known manner, mixtures of different surfactants having different HLB values.

Advantageously, the oil-in-water (O/W) type surfactant are emulsifiers having an HLB value sufficiently high to provide oil-in-water emulsions, i.e., an HLB value more than 9, preferably more than 10.

Examples of oil-in-water surfactants include, not limitatively, ethoxylated sorbitan esters like for example polyethoxylated sorbitan oleate with 20 moles of ethylene oxide, polyethoxylated sorbitan laurate with 20 moles of ethylene oxide, castor oil polyethoxylated with 40 moles of ethylene oxide, decaethoxylated oleodecyl alcohol, heptaethoxylated lauryl alcohol, decaethoxylated nonylphenol, polyethoxylated sorbitan hexaoleates, or mixtures thereof.

Preferably, the emulsifying system comprises from 20% to 50% of water-in-oil (W/O) type surfactant and from 80% to 50% of oil-in-water (O/W) type surfactants, percentages being expressed by weight with regards to the total weight of surfactants in the emulsifying system.

Preferably, the self-invertible inverse latex or the self-invertible inverse microlatex comprises from 2 to 20%, preferably from 2 to 8% by weight of emulsifying system as described above.

The preparation of the self-invertible inverse latex or microlatex used in the method according to the invention can be carried out by radical polymerization in an inverse water-in-oil emulsion, i.e., wherein the continuous phase is oily, in presence of water-in-oil surfactants. Oil-in-water surfactants as described above are added at the end of the polymerization step to modify and adjust the hydrophilic-lipophilic balance of the water-in-oil emulsion comprising the polyelectrolyte so as to obtain a mixture which, once mixed with water, will change the direction of emulsion from the water-in-oil form to the oil-in-water form, thus allowing the polyelectrolyte to be placed in contact with water. During such a physical phenomenon, the cross-linked polyelectrolyte polymer expands in water and forms microgels. In the method as defined above, the self-invertible inverse latex or the self-invertible inverse microlatex or the powder obtained therefrom, results after swelling in water in microgels which can be deformed, which are temperature stable, which are mechanically stable when subjected to high shear, and which are irreversibly adsorbed. The microgels used in the method according to the invention are non-degradable polymer particles and cannot irreversibly degrade through hydrolysis of their chemical bonds.

Advantageously, the microgels have a spherical shape and have an average size ranging from 0.05 μm to 10 μm, preferably from 0.1 to 8 μm, more preferably from 0.3 to 5 μm. The morphology of the microgels can be investigated for example by environmental scanning electron microscope.

The preparation of the microgels described above can be carried out according to techniques known to the skilled person and is described for example in patent U.S. Pat. No. 8,680,028 and in patent EP1799960.

The microgels used in the method according to the invention can also contain various additives such as complexing agents, transfer agents, or chain length limiting agents.

Advantageously, the first aqueous composition injected in step (i) comprises an amount of microgels as defined above ranging from 500 to 10 000 ppm, preferably from 500 to 7000 ppm. Lower concentrations can be used but are not generally very effective.

The first aqueous composition can optionally contain other ingredients such as salts, mineral acids, organic acids with low molecular weight, surfactants and wetting agents.

Preferably, the water used as solvent in the first aqueous composition has a moderate salinity, generally comprising from 1% to 5% of TDS (Total Dissolved Salt). The water may be production water, seawater, tap water, soft water (river water, running water) or mixtures thereof, or any other type of water having the desired salinity.

The applicant has found that the above-described microgels, due to their relatively large size, when injected in the subterranean formation, will spontaneously invade preferentially the zones of highest permeability, and will only to a very small extent spread into the zones of low permeability. As a consequence, the first aqueous composition comprising microgels will protect the relatively low permeability layers from the invasion of the subsequent injection of gel treatment of step (ii) of the method according to the invention.

It has been observed that the presence of a cationic monomer in the crosslinked polyelectrolyte injected in the form of microgels in step i) of the described process improves the performance of the process.

### The Second Aqueous Composition Capable of Generating a Gel In Situ in the Subterranean Formation

The method according to the invention comprises a second treatment step (ii) of the subterranean formation using a second aqueous composition which is capable of generating a gel in the subterranean formation after the injection of said aqueous composition.

The term “gel” as used herein means a continuous three-dimensional crosslinked polymeric network containing water confined within the solid polymeric network. Gels used in the method according to the invention have sufficient structure so as not to propagate from the confines of a plugged volume into a less permeable zone of the formation.

For the purpose of the present invention, the second aqueous composition capable of generating a gel in situ in the subterranean formation is also referred to as gelation composition, gelling system, or gel treatment as commonly used in the art.

It is noted that the second aqueous composition may comprise one or more gelling systems having different final strengths and/or different compositions.

Advantageously, the second aqueous composition capable of generating a gel in situ in the subterranean formation is an aqueous composition comprising at least one crosslinkable polymer and at least a crosslinking agent.

Advantageously, the crosslinkable polymer is a carboxylate-based polymer. A preferred carboxylate-based polymer is an acrylamide-based polymer. Of the acrylamide-based polymers, the most preferred are polyacrylamide (PA), partially hydrolyzed polyacrylamide (PHPA), copolymers of acrylamide and acrylate, carboxylate-containing terpolymers of acrylate, and copolymers of acrylamide and 2-acrylamido-2-methylpropanesulfonic acid.

For the purpose of the invention, an acrylamide polymer having substantially less than 1% of the acrylamide groups in the form of carboxylate groups is termed polyacrylamide.

For the purpose of the invention, an acrylamide polymer having at least 1% but not 100% of the acrylamide groups in the form of carboxylate groups is termed partially hydrolyzed polyacrylamide.

Advantageously, the degree of hydrolysis of the polyacrylamide polymer is from 0 to 60% and preferably from 0 to 30%.

According to an embodiment, the crosslinkable polymer is polyacrylamide. Preferably, the polyacrylamide has from about 0.1% to about 1% of its amide groups hydrolyzed.

According to another embodiment, the crosslinkable polymer is partially hydrolyzed polyacrylamide. Preferably, the partially hydrolyzed polyacrylamide has greater than 3% of its amide groups hydrolyzed.

According to another embodiment, the crosslinkable polymer is an acrylamide polymer containing 2-acrylamido-2-methylpropanesulfonic acid. Preferably, the acrylamide polymer has greater than 3% of 2-acrylamido-2-methylpropanesulfonic acid.

Advantageously, the average molecular weight of the acrylamide-based polymer is in the range of 10,000 to 50,000,000 g/mol⁻¹ and preferably from 100,000 to 20,000,000 g/mol⁻¹, and most preferably from 200,000 to 15,000,000 g/mol⁻¹.

The crosslinking agent effects crosslinking between the carboxylate sites of the same or different polymer molecules. The crosslinking agent used for the purpose of the invention can be organic or mineral.

For example, a mineral crosslinking agent can be a molecule or complex containing a reactive transition metal cation. A preferred crosslinking agent comprises a trivalent chromium cation complexed or bonded to an anion, oxygen or water. Exemplary preferred crosslinking agents are chromic triacetate and chromic trichloride. Such crosslinking agents are described for example in U.S. Pat. No. 4,683,949. Other examples of transition metal cations, can be for example chromium VI within a redox system, aluminium III within aluminum citrate or aluminum trichloride, iron II, iron III, and zirconium IV.

Amongst the organic crosslinking agent, examples include but are not limited to polyamines, polyethyleneimine, polyphenols.

According to a preferred embodiment, the crosslinking agent used in the method according to the invention is an organic crosslinking agent.

According to a preferred embodiment of the invention, the second aqueous composition capable of generating a gel in the subterranean formation is an aqueous composition comprising an acrylamide polymer and/or an acrylamide polymer containing 2-acrylamido-2-methylpropanesulfonic acid and an organic crosslinking agent.

Advantageously, the second aqueous composition capable of generating a gel in the formation comprises an amount of the crosslinkable polymer as defined above ranging from 500 to 120 000 ppm, preferably from 1000 to 110000 ppm and an amount of crosslinking agent ranging from 500 to 15 000 ppm, preferably from 500 to 12000 ppm. Lower concentrations can be used but are not generally very effective.

Advantageously, the weight ratio of the crosslinkable polymer to the crosslinking agent is about 1:1 to about 500:1, preferably about 2.5:1 to about 100:1, and most preferably about 5:1 to about 40:1.

The gelation rate of the gel treatment injected in step (ii) of the method according to the invention is advantageously sufficiently slow to enable preparation of the gelation composition at the surface, injection of the composition as a uniform slug into the well bore, and displacement of the entire composition into the desired treatment zone of the subterranean formation.

Advantageously, the contact time required for the gel treatment according to the invention to efficiently react in the subterranean formation is quite short and can be considered to be completed within from 12 hours to 21 days preferably from 1 day to 7 days.

This gelation time depends on various parameters, such as the type of the formation and the temperature. The person skilled in the art is able to determine the time it takes for the polymer to gel in the formation by using his general knowledge. The person skilled in the art is also able to delay or accelerate the gelling time according to his wishes or to the constraints which he can meet on the field.

Advantageously, the second aqueous composition comprising the gel treatment has a viscosity ranging from 1.5 mPa.s to 3500 mPa.s at 7.34 s⁻¹ and at 25 °C.

In situ gelation of the solution results in substantial permeability reduction of the higher-permeability zone in the subterranean formation.

The aqueous solvent of the second composition as described above may be fresh water or a brine having a total dissolved solids concentration up to the solubility limit of the solids in water. The aqueous solvent can be the same as used in the first aqueous composition. Inert fillers such as crushed or naturally fine rock material or glass beads can also be added to the second aqueous composition to reinforce the gel network structure.

### The Third Aqueous Composition

The method according to the invention further comprises a step (iii), immediately after step (ii), of injecting a third composition comprising water and optionally one or more viscosifying agents, in order to push the gel treatment injected in step ii) deeper into the subterranean formation.

According to an embodiment, the third aqueous composition comprises one or more viscosifying agent. Examples of viscosifying agent include but are not limited to acrylamide-based polymers, xanthan gums, guar gums or mixtures thereof.

According to a preferred embodiment, the viscosifying agent is an acrylamide-based polymer.

Advantageously, the acrylamide-based polymer has an average molecular weight ranging from 1,000,000 to 20,000,000 g.mol⁻¹.

Advantageously, the third aqueous composition comprises an amount of viscosifying agent ranging from 500 to 20 000 ppm, preferably from 500 to 15000 ppm. Lower concentrations can be used but are not generally very effective.

Advantageously, the third aqueous composition optionally comprising the viscosifying agent has a viscosity ranging from 1.5 mPa.s to 3500 mPa.s at 7.34 s⁻¹ and at 25 °C.

For all the steps (i) to (iii) of the method described in details above, those skilled in the art are able to adjust the flow rate for introducing or injecting the different treatment compositions as a function of the type of subterranean formation to be treated. In addition, the compositions can be introduced into the subterranean formation at the desired pressure, provided that said pressure is not above the fracturing pressure.

According to an embodiment, the method for improving conformance and/or fluid profiles according to the invention consists essentially in steps (i) and (ii) as described above.

According to another embodiment, the method for improving conformance and/or fluid profiles according to the invention consists essentially in steps (i), (ii) and (iii) as described above.

Advantageously, the steps i) and ii), and iii), of the method according to the invention are applied at most 21 days, preferably at most 7 days, and more preferably at most 1 day, before any injection of a displacement fluid. This depends in particular on the time needed for the gelation of the second composition injected in step ii).

The inventive method described herein selectively reduces the permeability of at least one relatively highly permeable zone of a subterranean formation to improve conformance and flow profiles of fluids injected into the subterranean formation.

Depending on the type of the formation, the method according to the present invention can be preceded by an optional pre-treatment step which can be carried out, for example, with an aqueous solution containing a surfactant, in order to clean the formation to be treated.

Advantageously, the method of the present invention can also be followed by a final step of injecting a displacement fluid, such as water, brine or gas in the formation, in order to invade the un-swept low permeability layers.

The method of the invention has many advantages, and notably requires limited operations. In addition, the treatments used in the invention are compatible with the anionic polymers used for example for Enhanced Oil Recovery and are compatible with surfactants used for example in Alkali Surfactant Polymer flooding.

Further, the method according to the invention has the advantage of being applicable over wide temperature ranges. For example, it can be carried out in a formation the temperature of which is between 0 °C and 200 °C.

### DESCRIPTION OF THE FIGURES

FIG. 1 represents the connection between a well-bore (1) drilled in a subterranean formation and in contact, through perforations (2), with two layers of different permeabilities, layer (3) having a lower permeability than layer (4).

FIG. 2 illustrates the invasion of all the layers of the subterranean formation of FIG. 1 when a prior art gel treatment is performed bull heading (5). The treatment invades both layers having different permeabilities.

FIGS. 3 to 6 illustrate the mechanism of the method according to the present invention to avoid the gel treatment to invade the low permeability layer in a subterranean formation corresponding to the formation represented in FIG. 1.

FIG. 3 represents the injection of the first aqueous composition comprising the microgel (6) that will invade mainly the high permeability layer (4) leaving a skin at the entrance of the low permeability layer (3).

FIG. 4 illustrates the subsequent injection of the second aqueous composition comprising the gelling treatment (7).

FIG. 5 illustrates the injection of the third aqueous composition (8), that can optionally comprise a viscosifying agent, that is intended to push the gel treatment (7) deeper into the subterranean formation.

FIG. 6 shows the subsequent injection of a displacement fluid (9) (after treatment of the formation with the method according to the invention) that will only invade the low permeability layer (3) through the skin of microgel (6).

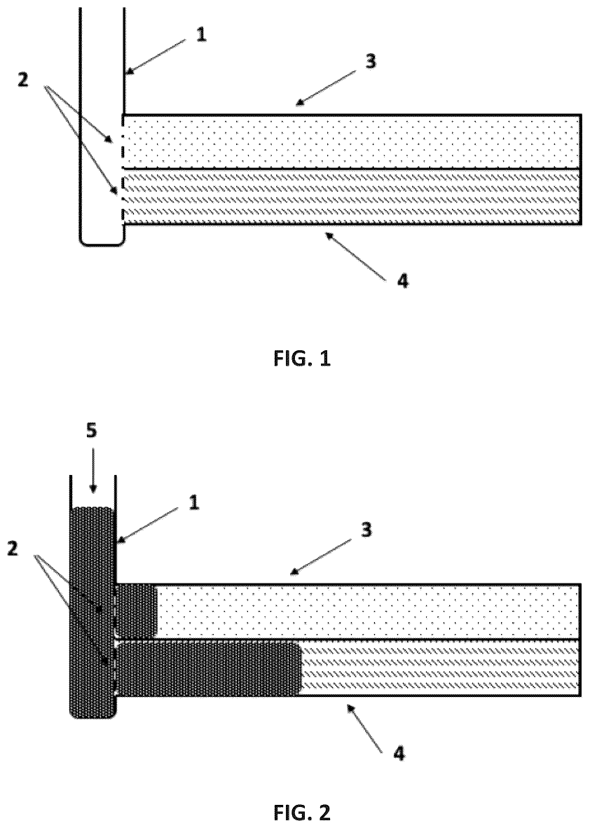

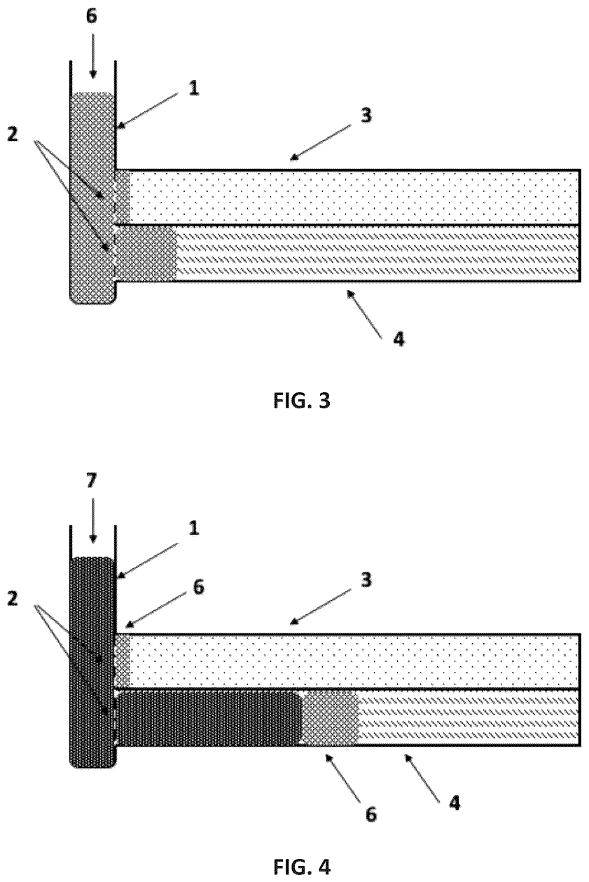

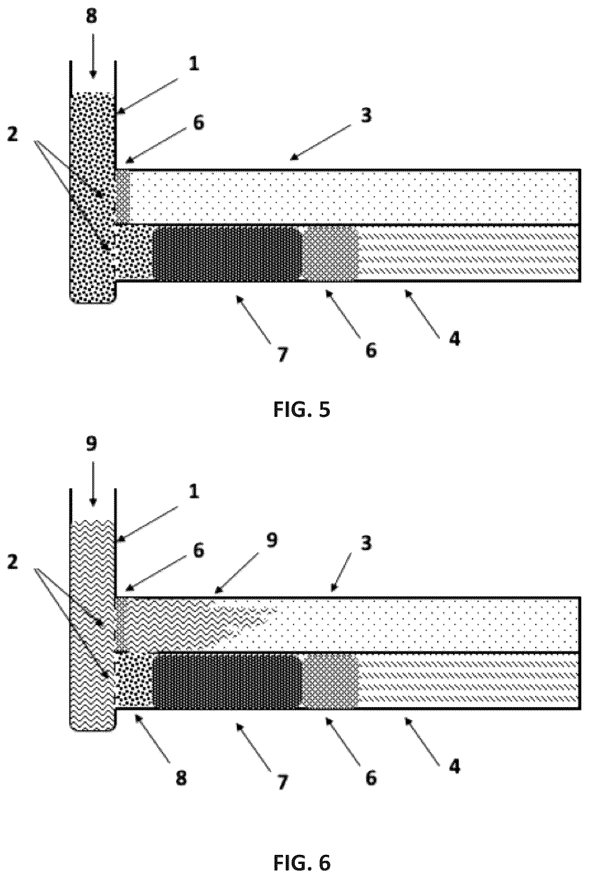

1. A method for improving conformance in hydrocarbon-bearing heterogeneous subterranean formations, the method comprising the steps of:
(i) injecting a first aqueous composition comprising microgels obtained by dispersing in water (a) a self-invertible inverse latex or a self-invertible inverse microlatex of a crosslinked polyelectrolyte, or (b) a powder obtained by drying and/or atomization of said self-invertible inverse latex or said self-invertible inverse microlatex,
the crosslinked polyelectrolyte being obtained by copolymerization in the presence of a crosslinking agent of:
at least one anionic monomer,
with at least one neutral monomer,
(ii) injecting a second aqueous composition capable of generating a gel in the subterranean formation,
(iii) injecting a third aqueous composition comprising at least water and optionally one or more viscosifying agent.

2. The method as claimed in claim 1, wherein in step (i), the anionic monomer is selected from the group consisting of (meth)acrylic acid, itaconic acid, crotonic acid, maleic acid, fumaric acid, 2-methyl-2-[(1-oxo-2-propenyl)amino]-1-propanesulfonic acid, vinylsulphonic acid, vinylphosphonic acid, allylsulphonic acid, allylphosphonic acid, styrene sulphonic acid and their salts of an alkali metal, an alkaline earth metal and ammonium, and mixtures of these monomers.

3. The method as claimed in claim 1, wherein in step (i), the proportion of the anionic monomer units in the crosslinked polyelectrolyte is from 1 to 75 mol %.

4-15. (canceled)

16. The method as claimed in claim 3, wherein in step (i), the proportion of the anionic monomer units in the crosslinked polyelectrolyte is from 5 to 40 mol %.

17. The method as claimed in claim 1, wherein in step (i), the neutral monomer is selected from the group consisting of: acrylamide; N, N-dimethylacrylamide; N-[2-hydroxy-1,1-bis(hydroxymethyl)-ethyl]propenamide;
or 2-hydroxyethyl acrylate; N-vinylpyrrolidone; and mixtures thereof.

18. The method as claimed in claim 1, wherein in step (i), the proportion of neutral monomer units in the crosslinked polyelectrolyte is from 10 to 90 mol % and preferably from 50 to 70 mol %.

19. The method as claimed in claim 18, wherein in step (i), the proportion of neutral monomer units in the crosslinked polyelectrolyte is from 50 to 70 mol %.

20. The method as claimed in claim 1, wherein the crosslinked polyelectrolyte is obtained by copolymerization with a further cationic monomer.

21. The method as claimed in claim 20, wherein in step (i), the proportion of cationic monomer units in the crosslinked polyelectrolyte is from 1 to 75 mol %.

22. The method as claimed in claim 1, wherein in step (i), the microgels have a spherical shape and have an average size ranging from 0.05 to 10 μm.

23. The method as claimed in claim 1, wherein in step (i), the first aqueous composition comprises an amount of microgels ranging from 500 to 10 000 ppm.

24. The method as claimed in claim 1, wherein in step (ii), the second aqueous composition capable of generating a gel in the subterranean formation is a composition comprising at least one crosslinkable polymer and at least a crosslinking agent.

25. The method as claimed in claim 24, wherein the crosslinkable polymer is an acrylamide-based polymer.

26. The method as claimed in claim 24, wherein the average molecular weight of the crosslinkable polymer is from 10,000 to 50,000,000 g/mol⁻¹.

27. The method as claimed in claim 24, wherein in step (ii), the second aqueous composition capable of generating a gel in the subterranean formation comprises an amount of the crosslinkable polymer ranging from 500 to 120 000 ppm.

28. The method of claim 24, wherein in step (ii), the second aqueous composition capable of generating a gel in the subterranean formation comprises an amount of crosslinking agent ranging from 500 to 15 000 ppm.

29. The method as claimed in claim 1, wherein the viscosifying agent is an acrylamide-based polymer.

30. The method as claimed in claim 1, wherein the steps i) and ii) and iii) are applied at most 21 days before any injection of a displacement fluid.

31. A method for improving flow profiles and sweep efficiencies of fluids injected in hydrocarbon-bearing heterogeneous subterranean formations, the method comprising the steps of:
(i) injecting a first aqueous composition comprising microgels obtained by dispersing in water (a) a self-invertible inverse latex or a self-invertible inverse microlatex of a crosslinked polyelectrolyte, or (b) a powder obtained by drying and/or atomization of said self-invertible inverse latex or said self-invertible inverse microlatex,
the crosslinked polyelectrolyte being obtained by copolymerization in the presence of a crosslinking agent of:
at least one anionic monomer,
with at least one neutral monomer,
(ii) injecting a second aqueous composition capable of generating a gel in the subterranean formation,
(iii) injecting a third aqueous composition comprising at least water and optionally one or more viscosifying agent.

32. A method for diverting fluids injected in hydrocarbon-bearing heterogeneous subterranean formations, the method comprising the steps of:
(i) injecting a first aqueous composition comprising microgels obtained by dispersing in water (a) a self-invertible inverse latex or a self-invertible inverse microlatex of a crosslinked polyelectrolyte, or (b) a powder obtained by drying and/or atomization of said self-invertible inverse latex or said self-invertible inverse microlatex,
the crosslinked polyelectrolyte being obtained by copolymerization in the presence of a crosslinking agent of:
at least one anionic monomer,
with at least one neutral monomer,
(ii) injecting a second aqueous composition capable of generating a gel in the subterranean formation,
(iii) injecting a third aqueous composition comprising at least water and optionally one or more viscosifying agent.
